(19) United States
(12) Patent Application Publication
(10) Pub. No.: US 2026/0298664 A1
(43) Pub. Date: Oct. 1, 2026

(54) METHOD FOR CREATING A DIGITAL ROAD MAP

(71) Applicant: Robert Bosch GmbH, Stuttgart (DE)

(72) Inventors: Hans-Georg Raumer, Hildesheim (DE); Max Kirstein, Hohenhameln - Ot Bruendeln (DE); Thomas Wenzel, Hamburg (DE); Thorben Funke, Sarstedt (DE)

(21) Appl. No.: 19/572,400

(22) Filed: Mar. 19, 2026

(30) Foreign Application Priority Data
Mar. 25, 2025 (DE) 10 2025 111 489.7

(51) Int. Cl. G01C 21/00

(52) U.S. Cl. CPC G01C 21/3841; G01C 21/3811; G01C 21/3815; G01C 21/3878

(57) ABSTRACT

A method for creating a digital road map. The method includes: receiving environmental data which represent an environment of a motor vehicle; processing the environmental data to extract at least one BEV feature from the environment; receiving input data representing one or more layers of a digital map of the motor vehicle's environment, wherein the one or more layers each comprise information about the motor vehicle's environment, processing the input data to extract, from the information, at least one further BEV feature from the environment; creating the digital road map on the basis of the at least one BEV feature extracted from the environmental data and the at least one further BEV feature extracted from the information. A device, a computer program, and a machine-readable storage medium, are also described.

### CROSS REFERENCE

The present application claims the benefit under 35 U.S.C. § 119 of Germany Patent Application No. DE 10 2025 111 489.7 filed on Mar. 25, 2025, which is expressly incorporated herein by reference in its entirety.

### FIELD

The present disclosure relates to a method for creating a digital road map, to a device, to a computer program, and to a machine-readable storage medium.

### BACKGROUND INFORMATION

Digital road maps are an important component of autonomous driving systems, as they can, for example, provide precise and comprehensive information about a driving scene.

It may be provided for such a digital road map to be created internally within the vehicle, which is known as “onboard map generation (OMG).” This involves creating a high-resolution map of a motor vehicle's current surroundings on the basis of sensor data, such as camera data, radar data and/or LIDAR data captured by motor vehicle sensors.

The OMG concept is described in the following article, for example: B. Liao, S. Chen, X. Wang, T. Cheng, Q. Zhang, W. Liu, and C. Huang, “Maptr: Structured modeling and learning for online vectorized hd map construction,” arXiv preprint arXiv: 2208.14437, 2022.

### SUMMARY

The underlying object of the present disclosure is to provide a concept for creating a digital road map.

This object may be achieved by means of certain features of the present disclosure. Advantageous example embodiments are disclosed herein.

According to a first aspect, a method for creating a digital road map is provided. According to an example embodiment, the method comprises the following steps:
receiving environmental data which represent an environment of a motor vehicle,
processing the environmental data to extract at least one BEV feature from the environment,
receiving input data representing one or more layers of a digital map of the motor vehicle's environment, wherein the one or more layers each comprise information about the motor vehicle's environment,
processing the input data to extract, from the information, at least one further BEV feature from the environment,
creating the digital road map on the basis of the at least one BEV feature extracted from the environmental data and the at least one further BEV feature extracted from the information.

According to a second aspect, a device is provided, which is configured to execute all steps of the method according to the first aspect.

According to a third aspect, a computer program is provided which comprises commands which, when the computer program is executed by a computer, for example by the device according to the second aspect, cause this computer to execute a method according to the first aspect.

According to a fourth aspect, a machine-readable storage medium is provided, on which the computer program according to the third aspect is stored.

The present disclosure is based on and includes the finding that the above object may be achieved by using, in addition to the environmental data ascertained, e.g., by environment sensors of the motor vehicle, information from one or more layers of a digital map of the environment of the motor vehicle to create the digital road map.

In other words, according to the concept described herein, an additional source of information is available for creating the digital road map: the one or more layers of the digital map of the environment or surroundings of the motor vehicle.

This allows for the creation of an accurate and reliable digital road map, on the basis of which, for example, a motor vehicle can drive at least partially automatically.

The abbreviation “BEV” stands for “bird's-eye view.”

A BEV feature includes, in particular, information about the motor vehicle's environment or surroundings presented from the bird's-eye view. One BEV feature is, for example, a tensor where for example two dimensions correspond to the longitudinal and lateral directions of travel of the motor vehicle respectively (i.e., for example, in front of/behind and left of/right of the motor vehicle, respectively).

The at least one BEV feature refers to the at least one BEV feature that was extracted from the environment on the basis of the processing of the environmental data. The at least one BEV feature is thus ascertained or extracted from the environmental data.

The at least one further BEV feature refers to the at least one further BEV feature that was extracted from the environment on the basis of the processing of the input data. The at least one further BEV feature is thus ascertained or extracted from the input data or from the information of the one or more layers.

In other words, the term “further” indicates that the BEV feature was extracted from the environment on the basis of the processing of the input data, i.e., on the basis of the information from the one or more layers of the digital map of the environment or surroundings of the motor vehicle.

The wording “at least one” means “one or more.”

Statements made in connection with a BEV feature or a further BEV feature apply analogously to a plurality of BEV features or a plurality of further BEV features, and vice versa.

A digital road map is, for example, an HD map, i.e., a high-definition map, that is a map with a high resolution.

Thus, for example, a digital HD road map will be created on the basis of the concept described herein.

The digital map of the environment or surroundings of the motor vehicle can be, for example, an HD map or an SD map, wherein SD stands for standard definition, that is, standard resolution.

In one example embodiment of the method, it is provided for the at least one BEV feature and the at least one further BEV to be fused, in particular added and/or concatenated, wherein the digital road map is created on the basis of the fusion.

This, for example, brings about the technical advantage that the digital road map can be created efficiently.

In one example embodiment of the method, it is provided for a grid with a width, a height and a resolution of the at least one BEV feature to be generated, wherein the input data are processed on the basis of the generated grid so that the at least one further BEV feature is defined in the same coordinate system as the at least one BEV feature.

This, for example, brings about the technical advantage that the input data can be efficiently processed.

In one example embodiment of the method, it is provided for processing of the input data to include extracting at least one further BEV feature for each layer, in particular using a multilayer perceptron and/or a CNN, wherein the respectively extracted further BEV features are fused, in particular added and/or concatenated, into a tensor, wherein the digital road map is created on the basis of the one tensor.

This, for example, brings about the technical advantage that the digital road map can be created efficiently.

In one example embodiment of the method, it is provided for the one tensor to be fused, in particular added and/or concatenated, with the at least one BEV feature, wherein the digital road map is created on the basis of the fusion.

This, for example, brings about the technical advantage that the digital road map can be created efficiently.

In one example embodiment of the method, it is provided for the one tensor to be processed as input data by a CNN and/or by an artificial neural segmentation network in order to output output data according to the processing, wherein the digital road map is created on the basis of the output data.

This, for example, brings about the technical advantage that the one tensor can be processed efficiently, so that the digital road map can be created efficiently as well.

“CNN” stands for convolutional neural network.

In one example embodiment of the method, it is provided for the output data to be fused, in particular added and/or concatenated, with the at least one BEV feature, wherein the digital road map is created on the basis of the fusion.

This, for example, brings about the technical advantage that the digital road map can be created efficiently.

Fusion in terms of the description generally includes, for example, adding and/or concatenating.

The wording “on the basis of the fusion” in terms of the description refers in particular to the result of the fusion. “On the basis of the fusion” therefore means “on the basis of a result of the fusion.”

In one example embodiment of the method, it is provided for the one or more layers to each be an element selected from the following group of layers: landmark layer, planning layer, behavioral layer, radar layer, lidar layer.

This, for example, brings about the technical advantage that particularly suitable layers may be provided.

A landmark layer in terms of the description includes, for example, a particular position of lane and/or road markings and/or of traffic signs.

A planning layer in terms of the description includes, for example, a centerline of the lanes and/or information about connected centerlines and/or relationships between traffic signs and lanes.

“Lane” refers to a driving lane. A driving lane can also be referred to as traffic lane.

Centerlines in terms of the description refer to the middle of a driving lane. A centerline is therefore equidistant from the left and right driving lane boundary lines.

A behavioral layer in terms of the description includes, for example, information on how drivers of motor vehicles behave within the driving lane(s). Such information includes, for example, an average trajectory traveled and/or information about a speed of the motor vehicles. A speed can be, for example, an average speed. Information includes, for example, a variance and/or a median of the speeds at which the motor vehicles travel and/or a quartile of the speeds at which the motor vehicles travel. Behavioral layer information includes, for example, clusters of braking and/or stopping and/or lane change maneuvers by motor vehicles.

A radar layer in terms of the description includes, for example, an aggregated representation of a radar view of the static surroundings, which was collected and processed from previous passings-by of a plurality of motor vehicles.

A lidar layer in terms of the description includes, for example, an aggregated representation of a lidar view of the static surroundings, which was collected and processed from previous passings-by of a plurality of motor vehicles.

In one example embodiment of the method, it is provided for the particular information of the one or more layers to be an element selected from the following group of information: information about road markings, information about traffic signs, segment information, traffic sign/lane relationships, information about trajectories traveled by motor vehicles, location-dependent speed profile of speeds at which motor vehicles travel, motor vehicle braking hotspots, motor vehicle stopping hotspots, motor vehicle lane change hotspots.

This, for example, brings about the technical advantage that particularly suitable information may be provided.

Device features result analogously from corresponding method features, and vice versa.

The method is, for example, a computer-implemented method.

The device is, for example, configured in terms of program technology to execute the computer program.

The method is, for example, carried out by means of the device.

The device is, for example, a computer.

The device comprises, for example, an input which is configured to receive the environmental data and the input data.

The device comprises, for example, one or more processors, each configured to process the environmental data and the input data, and to create the digital road map accordingly.

For example, the device comprises an output which is configured to output the created digital road map.

Therefore, for example, a step of outputting the created digital road map is provided for in the method.

In general, environmental data include one or more of the following data: image data, video data, radar data, lidar data, ultrasonic data, and infrared data.

The described example embodiments of the exemplary embodiments can be combined with one another in any way, even if this is not explicitly described.

The present disclosure is explained in more detail below using preferred exemplary embodiments.

### BRIEF DESCRIPTION OF THE DRAWINGS

FIG. 1 is a flowchart of a method for creating a digital road map according to an example embodiment.

FIG. 2 shows a device according to an example embodiment.

FIG. 3 shows a machine-readable storage medium according to an example embodiment.

FIG. 4 is a block diagram according to an example embodiment.

FIG. 5 to 9 are each a schematic representation of information from one layer of a digital map, according to an example embodiment.

FIG. 10 is a further block diagram, according to an example embodiment.

In the following, the same reference signs can be used for identical features.

### DETAILED DESCRIPTION OF EXAMPLE EMBODIMENTS

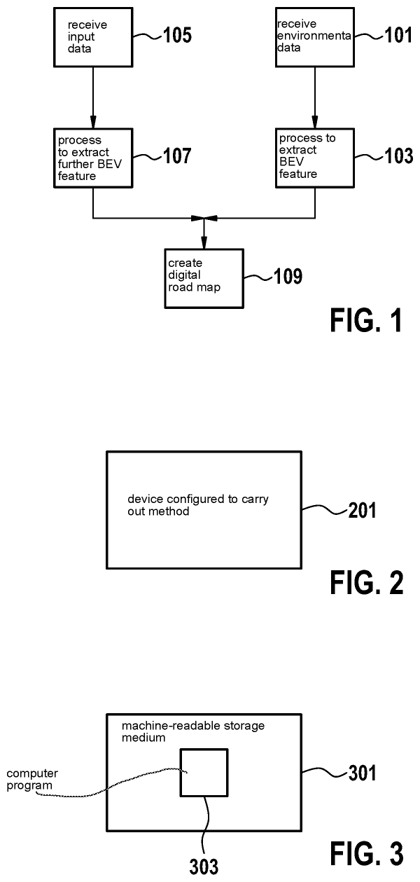

FIG. 1 is a flowchart of a method for creating a digital road map, comprising the following steps:
receiving 101 environmental data which represent an environment of a motor vehicle,
processing 103 the environmental data to extract at least one BEV feature from the environment,
receiving 105 input data representing one or more layers of a digital map of the motor vehicle's environment, wherein the one or more layers each comprise information about the motor vehicle's environment,
processing 107 the input data to extract, from the information, at least one further BEV feature from the environment,
creating 109 the digital road map on the basis of the at least one BEV feature extracted from the environmental data and the at least one further BEV feature extracted from the information.

FIG. 2 shows a device 201 which is configured to carry out all steps of the method for creating a digital road map.

FIG. 3 shows a machine-readable storage medium 301 on which a computer program 303 is stored. The computer program 303 comprises commands which, when the computer program 303 is executed by a computer, cause the computer to execute a method for creating a digital road map.

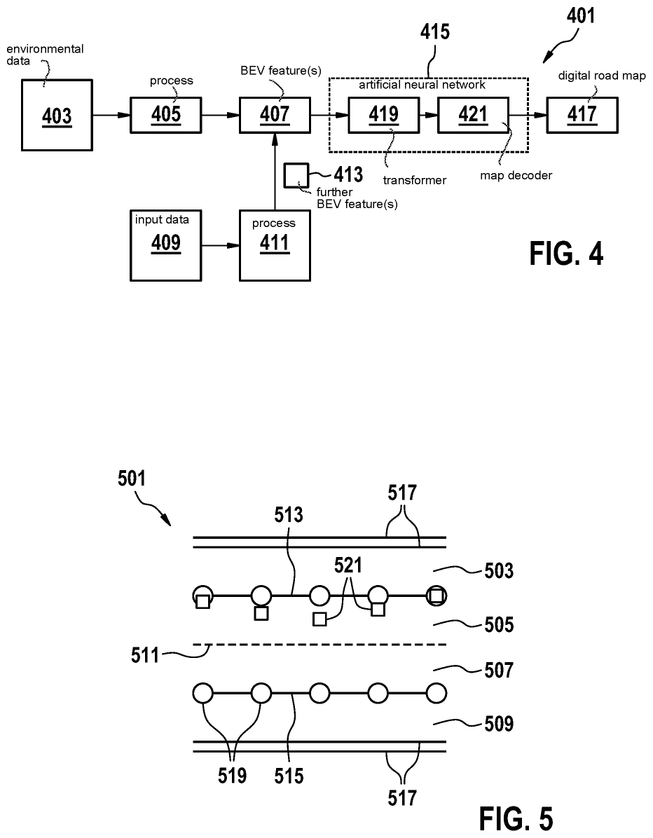

FIG. 4 is a block diagram 401, which by way of example illustrates the concept described here.

Environmental data 403 are received which represent an environment of a motor vehicle. The environmental data include, for example, image data and/or video data.

In general, environmental data include one or more of the following data: image data, video data, radar data, lidar data, ultrasonic data, and infrared data.

The environmental data 403 are processed according to a function block 405 in order to extract at least one BEV feature 407.

Furthermore, input data 409 are received, which represent one or more layers of a digital map of the environment or surroundings of the motor vehicle, wherein the one or more layers each contain information about the surroundings of the motor vehicle. These input data 409 are processed according to a function block 411 in order to extract, from the information, at least one further BEV feature 413 from the environment.

The terms “environment” and “surroundings” can be used synonymously in the context of the description.

The at least one BEV feature 407, which was ascertained from the environmental data, and the at least one further BEV feature 413, which was ascertained from the input data, can be provided, for example, to an artificial neural network 415.

For example, it may be provided to fuse the at least one BEV feature 407 and the at least one further BEV feature 413 together, wherein a result of this fusion is provided to the artificial neural network 415.

The artificial neural network 415 thus processes, for example, a result of the fusion and/or the BEV features 407, 413 separately, in order to create a digital road map 417 on the basis thereof.

For example, the artificial neural network 415 includes a transformer 419 and a map decoder 421.

The transformer 419 is, for example, an architecture of artificial neural networks used to calculate features. For example, self layers, cross layers, and normalization layers are used to, for example, iteratively refine the features, so-called queries. The map decoder 421, for example, calculates the desired explicit features, such as the position of the line points and/or the type of line, on the basis of the implicit “queries.”

FIGS. 5 to 9 are each schematic representations of information as may be present in one or more layers of a digital map of the motor vehicle's environment.

FIG. 5 is by way of example a schematic representation of line data.

FIG. 5 shows, in detail, a road 501. The road 501 has four driving lanes: a first driving lane 503, a second driving lane 505, a third driving lane 507 and a fourth driving lane 509.

Here, the first driving lane 503 and the second driving lane 505 are associated with a first direction of travel, which, for example, runs from right to left relative to the paper plane. The third driving lane 507 and the fourth driving lane 509 are associated with a direction of travel opposite to the first direction of travel, which thus runs from left to right relative to the paper plane.

The two driving lanes 503, 505 are separated by a boundary line 511 from the two driving lanes 507, 509. The first driving lane 503 and the second driving lane 505 are separated from one another by a second boundary line 513. The third driving lane 507 and the fourth driving lane 509 are separated from one another by a third boundary line 515.

The four driving lanes 503, 505, 507, 509 as a whole are bounded by two further boundary markings 517.

In FIG. 5, circles are drawn which are provided with reference sign 519, wherein not all of the drawn circles have reference sign 519. Quadrilaterals with reference sign 521 are also shown.

The circles 519 mark the respective driving lane boundaries 513, 515 between the corresponding driving lanes 503, 505 and 507, 509 respectively. Furthermore, these circles 519 can represent a speed profile of speeds at which motor vehicles travel.

The quadrilaterals 521 represent an average trajectory traveled.

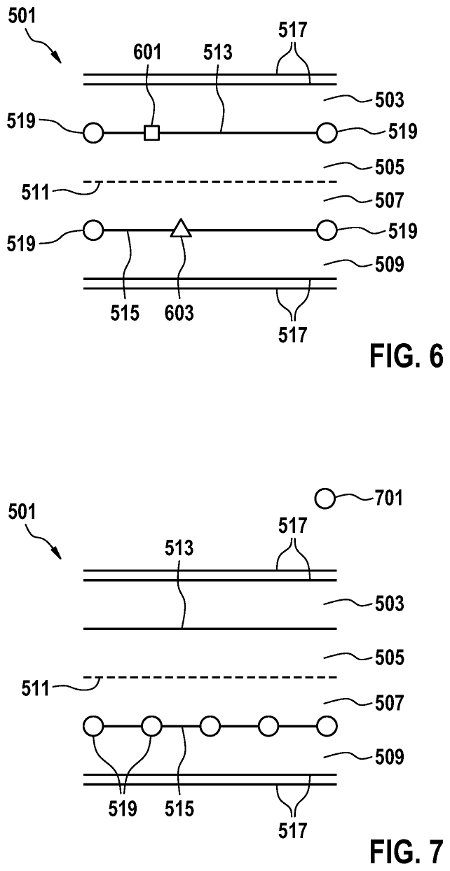

FIG. 6 is a schematic representation of point data. Specifically, a quadrilateral with reference sign 601 is shown, which represents a motor vehicle braking/stopping hotspot. Reference sign 603 indicates a triangle which represents a motor vehicle lane change hotspot.

FIG. 7 is a schematic representation of line and point data. Reference sign 701 symbolically points to a circle which represents a position of a traffic sign, wherein the traffic sign is located next to the first driving lane 503.

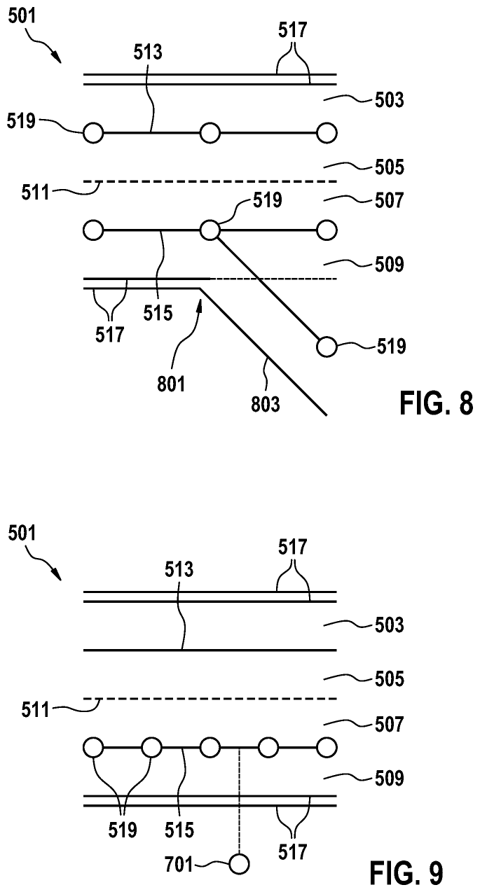

FIG. 8 is a schematic representation of segment information. It can be seen that the road 501 has a turnoff 801, from which a further road 803 branches off. The circles with reference sign 519 thus also mark a driving lane boundary marking for this further road 803.

FIG. 9 is a schematic representation of the relationship between traffic signs and driving lanes. Specifically, an example is shown of a circle with reference sign 701, which, as described above in connection with FIG. 7, indicates a position of a traffic sign.

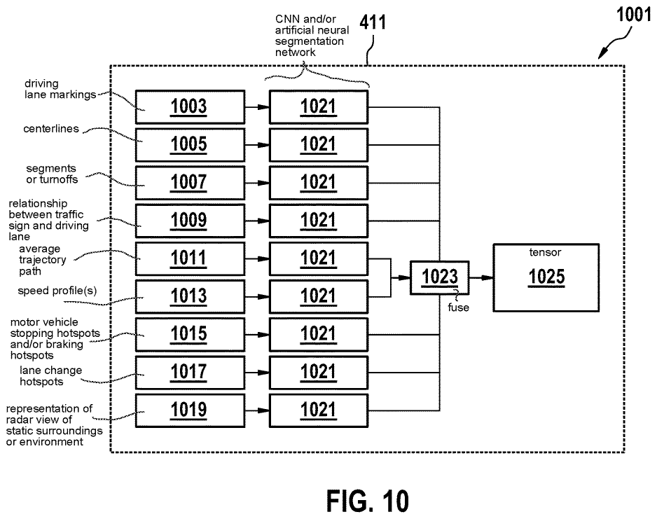

FIG. 10 is a further block diagram 1001. The further block diagram 1001 describes, by way of example, the function block 411 of FIG. 4. According to function block 411, information present in the layers of the digital map of the motor vehicle's environment is processed. This information is marked, by way of example, by a plurality of blocks with the following reference signs: 1003, 1005, 1007, 1009, 1011, 1013, 1015, 1017 and 1019.

The block with reference sign 1003 thus indicates, by way of example, information about driving lane markings.

The block with reference sign 1005 indicates, by way of example, information about centerlines.

The function block with reference sign 1007 indicates, by way of example, information about segments or turnoffs.

The function block with reference sign 1009 indicates, by way of example, information about “TE2Lane.” “TE2Lane” means “traffic element to lane,” i.e., the relationship between traffic sign and driving lane.

The block with reference sign 1011 contains information about an average trajectory path.

The block with reference sign 1013 contains information about a speed profile or speed profiles.

The block with reference sign 1015 contains information about motor vehicle stopping hotspots and/or braking hotspots.

The block with reference sign 1017 contains information about lane change hotspots.

The block with reference sign 1019 contains exemplary information about a representation of a radar view of the static surroundings or static environment.

This information can be processed by a CNN (convolutional neural network) and/or by an artificial neural segmentation network. In the further block diagram 1001, reference sign 1021 indicates a CNN and/or an artificial neural segmentation network.

An artificial neural segmentation network is referred to in English as a “multi-layer perceptron (MLP).”

Processing by the artificial neural network(s) 1021 includes extracting further BEV features, which are fused into a tensor with the respective extracted further BEV features according to a function block 1023. In the further block diagram 1001, the tensor is labeled with reference sign 1025.

The further block diagram 1001 thus symbolically illustrates by way of example how at least one further BEV feature is extracted for each layer, wherein a CNN and/or an MLP is used for this purpose.

The tensor 1025 can, for example, be fused with the at least one BEV feature 407 according to block diagram 401, wherein a result of this fusion is then provided to the artificial neural network 415 in order to create the digital road map 417 accordingly.

In summary, the concept described herein is based on using information from one or more layers of a digital map of the environment of the motor vehicle in addition to the environmental data ascertained, for example, by environment sensors of a motor vehicle, in order to extract, from this information, at least one further BEV feature from the environment. Thus, the digital road map is created not only on the basis of the at least one BEV feature extracted from the environmental data, but also on the basis of the at least one further BEV feature extracted from the information.

One advantage of the concept described herein is in particular that this additional information allows significantly richer information to be provided to the artificial neural network that creates the digital road map.

Furthermore, a BEV tensor can, for example, inherently include position information, and by combining it with the BEV features extracted from the environmental data, no change to the artificial neural network 415 may be necessary. Thus, a performance of the artificial neural network 415 can be significantly improved.

For example, it is provided that the input data will be transformed into BEV images. For example, the appropriately constructed BEV tensor can then either be used directly and/or processed individually by encoders and/or processed together with an encoder and then fused with the BEV features extracted from the environmental data.

The input data can be transformed, for example, in a so-called “dense representation” analogous to the BEV features of the environmental data. “Dense representation” refers in particular to a dense tensor and/or a dense matrix. The input data can thus be represented, for example, by a dense tensor and/or a dense matrix. The term “dense” should be seen in particular in contrast to “sparse.”

This has the advantage, for example, that the position information does not need to be represented additionally, but results directly from the representation. Thus, a grid with a width, height, and resolution of the BEV features of the environmental data is created, and the input data are transferred into a grid with channels per input data. This means, in particular, that BEV features are generated from the layers of the digital map in the same grid as the BEV features of the environmental data.

Input data include, for example, landmark layers and/or planning layers.

Information includes, for example, information about road markings or driving lane markings, such as centerlines. Any markings and centerlines that appear can be indicated with, for example, “1.” This can, for example, create a motion image where markings or centerlines are shown in white and the rest is shown in black.

The same procedure can be used for traffic signs as for markings. However, here the traffic sign can be extended over a plurality of pixels within a radius.

Regarding segment information, it should be noted that, for example, in an additional channel the centerlines are indexed per pixel. In a further channel, tuples of matching centerline indices are then entered at the pixel coordinates of the connected centerlines.

Regarding the traffic sign/lane relationships, it should be noted that, for example, indices for traffic signs can also be stored in a separate channel. In a further channel, the tuples of the indices of the traffic sign centerlines associated with one another can then be entered at the pixel coordinates of the centerlines.

A layer in terms of the description can be, for example, a behavioral layer.

For example, the information from such a behavioral layer can include an average travel trajectory. It should be noted that, for example, instead of summarizing the trajectories to an average value, the observed distribution can be used in the dense representation, and they can be represented as a heat map. Thus, a channel with values of 0 and 1 can be obtained, representing the probability of a motor vehicle being at that location.

Furthermore, information about speed profiles may be provided. For example, for a speed profile it may be provided to first enter the average speed, speed variance, median speed, first and third quartile of speed into different channels for all pixels of the driving lane.

Regarding stopping and braking hotspots, for example, it should be noted that these hotspots can be translated into a heat map, and a suitable spatial extent, such as a radius of 2 m, can be given to the hotspots.

Regarding the driving lane change hotspots, it should be noted that, for example, the same representation is used for the braking and/or stopping hotspots. For example, information about which driving lane is typically changed to is encoded in further channels.

Regarding radar information or radar layers, it should be noted that for radar layers, for example, the same heat/occupancy strategy is used as for the road markings, wherein the radar points of the radar layer are used in that case. The same applies to lidar layers.

The raw dense representations of the individual input data or information thus constructed can now optionally be processed first by a simple network such as an MLP and/or CNN. The results of these processing operations can then be concatenated into a tensor. Then, for example, it may be provided to optionally process the common BEV features using, e.g., a CNN, such as a ResUnit or models from the segmentation. A fusion can, for example, involve concatenation and/or addition.

What is claimed is:

1. A method for creating a digital road map, comprising the following steps:
receiving environmental data which represent an environment of a motor vehicle;
processing the environmental data to extract at least one bird's-eye view (BEV) feature from the environment;
receiving input data representing one or more layers of a digital map of the environment of the motor vehicle, wherein each of the one or more layers include respective information about the environment of the motor vehicle;
processing the input data to extract, from the respective information, at least one further BEV feature from the environment; and
creating the digital road map based on the at least one BEV feature extracted from the environmental data and the at least one further BEV feature extracted from the respective information.

2. The method according to claim 1, wherein the at least one BEV feature and the at least one further BEV feature are fused, including being added and/or concatenated, wherein the digital road map is created based on the fusion.

3. The method according to claim 1, wherein a grid with a width, a height, and a resolution, of the at least one BEV feature is generated, wherein the input data are processed based on the generated grid so that the at least one further BEV feature is defined in a same coordinate system as the at least one BEV feature.

4. The method according to claim 1, wherein the processing of the input data includes respectively extracting at least one further BEV feature for each layer of the one or more layers, using a multilayer perceptron and/or a convolutional neural network (CNN), wherein the respectively extracted further BEV features are fused, including being added and/or concatenated, into a tensor, wherein the digital road map is created based on the tensor.

5. The method according to claim 4, wherein the tensor is fused, including being added and/or concatenated, with the at least one BEV feature, wherein the digital road map is created based on the fusion.

6. The method according to claim 4, wherein the tensor is processed as input data by a convolutional neural network (CNN) and/or by an artificial neural segmentation network in order to output output data according to the processing by the CNN and/or by the artificial neural segmentation network, wherein the digital road map is created based on the output data.

7. The method according to claim 6, wherein the output data are fused, including being added and/or concatenated, with the at least one BEV feature, wherein the digital road map is created based on the fusion.

8. The method according to claim 1, wherein the one or more layers are each an element selected from the following group of layers: landmark layer, planning layer, behavioral layer, radar layer, lidar layer.

9. The method according to claim 1, wherein the respective information of each of the one or more layers is an element selected from the following group of information: information about road markings, information about traffic signs, segment information, traffic sign/lane relationships, information about trajectories traveled by motor vehicles, location-dependent speed profile of speeds at which motor vehicles travel, motor vehicle braking hotspots, motor vehicle stopping hotspots, motor vehicle lane change hotspots.

10. A device configured to create a digital road map, the device configured to perform the following steps comprising:
receiving environmental data which represent an environment of a motor vehicle;
processing the environmental data to extract at least one bird's-eye view (BEV) feature from the environment;
receiving input data representing one or more layers of a digital map of the environment of the motor vehicle, wherein each of the one or more layers include respective information about the environment of the motor vehicle;
processing the input data to extract, from the respective information, at least one further BEV feature from the environment; and
creating the digital road map based on the at least one BEV feature extracted from the environmental data and the at least one further BEV feature extracted from the respective information.

11. A non-transitory machine-readable storage medium on which is stored a computer program for creating a digital road map, the computer program, when executed by a computer, causing the computer to perform the following steps comprising:
receiving environmental data which represent an environment of a motor vehicle;
processing the environmental data to extract at least one bird's-eye view (BEV) feature from the environment;
receiving input data representing one or more layers of a digital map of the environment of the motor vehicle, wherein each of the one or more layers include respective information about the environment of the motor vehicle;
processing the input data to extract, from the respective information, at least one further BEV feature from the environment; and
creating the digital road map based on the at least one BEV feature extracted from the environmental data and the at least one further BEV feature extracted from the respective information.
